(19) United States
(12) Patent Application Publication
(10) Pub. No.: US 2026/0236255 A1
(43) Pub. Date: Aug. 13, 2026

(54) INTELLIGENTLY IDENTIFYING SOURCE CODE FROM COMPILED CODE

(71) Applicant: Oracle International Corporation, Redwood Shores, CA (US)

(72) Inventors: Animesh Agarwal, Dulles, VA (US); Grayson Cox, Columbia, MD (US); Ehsan Nick Minaie, Columbia, MD (US)

(73) Assignee: Oracle International Corporation, Redwood Shores, CA (US)

(21) Appl. No.: 19/053,220

(22) Filed: Feb. 13, 2025

(51) Int. Cl. G06F 8/75; G06F 8/35

(52) U.S. Cl. CPC G06F 8/75; G06F 8/35

(57) ABSTRACT

Systems, methods, and computer-readable media are provided for code analysis. The code analysis system disassembles a particular set of executable code to determine a particular set of translated code and generates a particular translated code vector embedding in an embedding space. The system also generates, for a plurality of sets of source code, a plurality of source code vector embeddings in the embedding space. The system accesses a model trained on training data comprising pairs of translated code and known source code to predict one or more particular sets of source code that are similar to the particular set of translated code based at least in part on vector distances between the plurality of source code vector embeddings and the particular translated code vector embedding. The system causes display of information indicating the one or more predicted sets of source code.

### BACKGROUND

Determining the source of an error or vulnerability within code is a time-consuming process that can extend the software development cycle. When a program is run, the program is executed as compiled code which is generated from compiling the source code that the program is written in. Determining the specific location within the source code may be difficult and time consuming even if a location of an error or vulnerability within the compiled code is identified.

Compiled code is difficult for humans to interpret. For that reason, manual analysis of compiled code is too time consuming or difficult for most cases. Standard decompilation does not significantly improve the ease of human interpretation. Some methods have been used to generate potential source code from compiled code. These methods may be slow and inefficient as well as potentially inaccurate in representing the original source code.

### BRIEF SUMMARY

In some embodiments, a system, article, and computer-implemented method are disclosed for code analysis. A particular set of executable code is disassembled to determine a particular set of translated code and a particular translated code vector embedding is generated in an embedding space. For a plurality of sets of source code, a plurality of source code vector embeddings is also generated in the embedding space. A model is accessed, the model trained on training data including pairs of translated code and known source code, to predict one or more particular sets of source code that are similar to the particular set of translated code based at least in part on vector distances between the plurality of source code vector embeddings and the particular translated code vector embedding. Information indicating the one or more predicted sets of source code associated with the particular set of translated code is displayed.

In a particular embodiment, a computer-implemented method includes disassembling a particular set of executable code to determine a particular set of translated code, for the particular set of translated code, generating a particular translated code vector embedding in an embedding space, for a plurality of sets of source code, generating a plurality of source code vector embeddings in the embedding space, accessing a machine learning model trained on training data including pairs of sets of translated code and known sets of source code to predict one or more particular sets of source code that are similar to the particular set of translated code based at least in part on vector distances between the plurality of source code vector embeddings and the particular translated code vector embedding in the embedding space, and the embedding space assigns different weights to different features based at least in part on which features were similar among the pairs in the training data, and causing display of information indicating the one or more particular sets of source code are associated with the particular set of executable code

In a further embodiment, the one or more particular sets of source code include two or more particular sets of source code that are each similar to the particular set of translated code, the computer-implemented method further includes ranking the two or more particular sets of source code based at least in part on a cosine distance between vector embeddings of each of the two or more particular sets of source code and the particular translated code vector embedding, and causing display of the information includes causing display of the two or more particular sets of source code according to the ranking.

In the same or a different further embodiment, the pairs of sets of translated code and known sets of source code are processed by a contrastive loss function to determine which vector components are similar for the pairs and which other vector components are dissimilar for the pairs.

In the same or a different further embodiment, generating the particular translated code vector embedding includes making a request to a generative model with one or more subsets of the particular set of translated code to determine whether the particular set of translated code includes one or more items of functionality and/or other semantic meaning(s) that are recorded in the particular translated code vector embedding, and generating the plurality of source code vector embeddings includes making a request to the generative model with one or more subsets of the plurality of sets of source code to determine whether the plurality of sets of source code includes one or more items of functionality that are recorded in the plurality of source code vector embeddings.

In another embodiment that extends the particular embodiment or any further embodiment, the computer-implemented method further includes generating another particular vector embedding of a particular subset of the particular set of translated code in the embedding space, generating another plurality of source code vector embeddings for a plurality of subsets of source code in the embedding space, and accessing the machine learning model to predict one or more particular subsets of source code that are similar to the particular subset of the particular set of translated code based at least in part on vector distances between the other plurality of source code vector embeddings and the other particular vector embedding in the embedding space.

In another embodiment that extends the particular embodiment or any further embodiment, generating the particular translated code vector embedding in the embedding space includes generating a first particular vector embedding of a first particular subset of translated code in the embedding space, and generating a second particular vector embedding of a second particular subset of translated code in the embedding space. Generating the plurality of source code vector embeddings in the embedding space may also include generating the plurality of source code vector embeddings for a plurality of subsets of source code in the embedding space. Accessing the machine learning model to predict one or more particular sets of source code that are similar to the particular set of translated code may also include accessing the machine learning model to predict a first particular subset of source code that is similar to the first particular subset of translated code based at least in part on vector distances between the plurality of source code vector embeddings and the first particular vector embedding, and accessing the machine learning model to predict a second particular subset of source code that is similar to the second particular subset of translated code based at least in part on vector distances between the plurality of source code vector embeddings and the second particular vector embedding.

In another embodiment that extends the particular embodiment or any further embodiment, the first particular subset of source code is non-contiguous with the second particular subset of source code.

In another embodiment that extends the particular embodiment or any further embodiment, causing display of the information includes annotating different parts of translated code corresponding to the particular set of executable code, the annotating marks the different parts of the translated code with corresponding parts of the one or more particular sets of source code.

In an alternative embodiment, a computer implemented method includes accessing a particular set of untranslated code, generating a particular untranslated code vector embedding in an embedding space, for a plurality of sets of translated code, generating a plurality of translated code vector embeddings in the embedding space, accessing a machine learning model trained on training data including pairs of sets of untranslated code and known sets of translated code to predict one or more particular sets of translated code that are similar to the particular set of untranslated code based at least in part on vector distances between the plurality of translated code vector embeddings and the particular untranslated code vector embedding in the embedding space, the embedding space assigning different weights to different features based at least in part on which features were similar among the pairs in the training data, and causing display of information indicating the one or more particular sets of translated code are associated with the particular set of untranslated code.

In another embodiment that extends the alternative embodiment, the particular set of untranslated code includes source code and the one or more particular sets of translated code includes compiled code

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process for code analysis.

FIG. 2 illustrates a system diagram showing an example cloud infrastructure for code analysis.

FIG. 3 illustrates a diagram of an example user interface for selecting a particular executable code and displaying a similar source code.

FIG. 4 depicts a simplified diagram of a distributed system for implementing certain aspects.

FIG. 5 is a simplified block diagram of one or more components of a system environment by which services provided by one or more components of an embodiment system may be offered as cloud services, in accordance with certain aspects.

FIG. 6 illustrates an example computer system that may be used to implement certain aspects.

### DETAILED DESCRIPTION

Systems, methods, and computer-readable media are provided for code analysis. The code analysis system disassembles a particular set of executable code to determine a particular set of translated code and generates a particular translated code vector embedding in an embedding space. The system also generates a plurality of source code vector embeddings for a plurality of sets of source code. The system accesses a machine learning model to predict one or more particular sets of source code that are similar to the particular set of translated code based at least in part on vector distances between the plurality of source code vector embeddings and the particular translated code vector embedding. The system causes display of information indicating the one or more predicted sets of source code. In various embodiments, the code analysis system is implemented using non-transitory computer-readable storage media to store instructions which, when executed by one or more processors of a computer system, cause display of the user interface and processing of the received input to determine a similar source code for a particular executable code. The code analysis system may be implemented on a local or cloud-based computer system that includes processors and optionally a client device display for showing the user interface to a user for code analysis. The computer system may communicate with client computer systems for code analysis.

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Generating Code Vector Embeddings

When developing software, a program is written as source code in a programming language that is human-readable as the code contains sufficient syntax to convey the intended functionality. Programming languages may include, for example, C, C++, C#, Java, Python, Go, etc. When a program is to be executed, the source code is compiled or otherwise translated into compiled code or other translated code which is optimized for execution or other consumption by a computer and may be directly executable by the computer using a native instruction set of the computer or a low-level language that may have a mapping onto the native instruction set of the computer. Due to the optimization of compiled or other translated code for computer consumption, the compiled or other translated code often may not be easily human-readable as the compiled or other translated code may lack some of the syntax and organization of the pre-compiled or pre-translated code that promote readability of the pre-compiled or pre-translated code. Compiled or other translated code may include or be represented as, for example, machine code, binary code, executable code, assembly code or other low-level code, which is a human-readable form of machine code that has been determined based on compilation or translation from source code and may be executable by a computer or a closer representation of what (e.g., step by step, native instruction by native instruction) is actually executed by the computer. Other compiled or translated code may include, for example, Java bytecode, minified JavaScript, or Python bytecode.

The translated code may be determined based on the source code, for example, by compiling or otherwise translating the source code and/or based on the executable code (e.g., machine code), for example, by decompiling or otherwise translating the executable code back into a more human-readable form. In this manner, the translated code may serve as a medium for comparisons made between source code representations and executable code representations, even if the translation mechanism does not perfectly represent or detect all aspects of functionality of the code as translated. Therefore, when a user desires to know something about the source code from the executable code, the executable code may first be decompiled into translated code to serve as a medium for comparison to the source code.

Part of the process of developing software is “debugging” or determining the source of errors or vulnerabilities, generically called “bugs.” Bugs within translated code may include, for example, errors such as memory corruption or vulnerabilities such as cross site scripting. When analyzing compiled or otherwise translated code for a software program, an error or vulnerability may be identified at a specific location within the compiled or translated code; however, fixing a detected error or vulnerability often involves identifying the error or vulnerability within the source code.

When trying to determine the location of an error or vulnerability in source code via a detected error or vulnerability in the compiled or translated code, part or all of the original source code may be available. Additionally, or alternatively, an analogous source code may be available. Even if the original source code is available, determining the location within the source code that corresponds to an error or vulnerability in the translated code is infeasible for manual analysis due to the difficulty of analyzing the translated code and the high volumes of code being analyzed when such code analysis is performed in enterprise code development environments with hundreds, thousands, or more sets of code under analysis. This problem continues to compound as the size of a software project increases and the amount of both source code and translated code increases. Even for small software projects, a volume of labeled code examples may include hundreds or thousands of source code examples paired with translated code examples, and finding a most appropriate labeled code example relevant to a small set of code may still be infeasible in such scenarios due to the large set of possibly relevant code examples. Without labeled code examples, there may not be a direct mapping between the translated code and the source code such that an error or vulnerability located in the translated code may still require manual analysis of the source code with only the limited aid of the difficult-to-interpret translated code.

In order to determine a location within source code corresponding to an identified location within translated code, one or more machine learning models may be used to convert the available code into vector embeddings in a latent space, which may then be used to determine a similarity by comparing vector embeddings. In this way, a specific file or location within source code may be identified such as to trace back the source of an error or vulnerability. In another embodiment, source code may be available that is similar to an unavailable source code, and a similarity to the available source code may be identified from analyzing an available translated code snippet such as in the case of analyzing a piece of software where the executable, translated code is available but the source code is not entirely available.

In one embodiment, a machine learning model called an encoder model may be trained on pre-compiled or pre-translated code to convert pre-translated code into a vector in a latent space. The vector in the latent space may be a normalized vector with a number of dimensions representing different semantics within the text of the code. The vector may be normalized such that a comparison of the distance of the vector from another vector may be performed based on the angle between the vectors. The machine learning model may be language-dependent or may be trained on multiple pre-translated code languages. An encoder model may contain multiple machine learning models trained on separate pre-translated code language and a language detection function for determining a machine learning model to use based on the pre-translated code language detected within the source code. The same or another machine learning model as used for the pre-translated code may also be trained on translated code to convert the translated code into a vector in the same or another latent space.

The encoder model may be trained on tokenized data of source code such that the encoder model learns to generate vector embeddings for input source code. A set of source code, such as a source code database or library, may be used as a training set of source code. For use in training the encoder model, the set of source code may be tokenized such as by using a text tokenizer such as a tokenizer for programming languages. Tokenization generates tokens which represent units of meaning or semantics within the source code. The tokens generated along with the corresponding source code may then be used to train the encoder model.

The encoder model may or may not use, as part of encoding the set of source code into vector embeddings, a generative model to determine a functionality of the code. A request may be generated including the source code component section to be encoded which is used to make a request to a generative model to determine functionality of the source code component section. The generative model may determine one or more items of functionality for the source code component section, which may then be used by the encoder model in encoding the source code component section into a vector embedding. The items of functionality may be represented as syntactic features which may be used to develop the feature vector within the latent space for the source code component section. The generative model may also be used to determine one or more items of functionality from a plurality of candidate items of functionality that the source code component section does not contain. Each item of functionality of the plurality of candidate items of functionality may correspond to a feature of the latent space vectors generated for each source code component section. Therefore, a determination by the generative model that a certain item of functionality of the plurality of candidate items of functionality does not exist within the source code component section may be used to develop the feature vector with in the latent space for the source code component section by decreasing the strength of the corresponding feature for the certain item of functionality.

In one example embodiment, a request may be made to a generative model to support encoding a section of code to a vector embedding to determine an item of functionality or other semantic meaning(s) where the section of code accesses a network resource of the device executing the code. The generative model may detect the item of functionality being a network resource request, which may correspond to a network resource feature of the vector embeddings of the latent space. The generative model may return the detected item of functionality, which may be used in generating the vector embedding to increase the prominence of the network resource feature in the vector embedding.

The same encoder model or a different encoder model may also be trained using translated code such that it can generate vector embeddings for translated code. The same encoder model or a different encoder model may be trained using a database of translated code such as the resulting translated code from, for example, compiling a database of source code such as a source code library. For example, large codebases such as the Linux kernel or open-source native libraries for mobile applications such as FFMPEG may be translated for the target architecture to generate pairwise datasets of source code and translated code. Block-, section-, or function-level pairs may be extracted from their control flow graphs from both the pre-translated code and the translated code.

An encoder model trained on pre-translated code may be used with parts or all of the original source code to generate a vector embedding in latent space for each of the component sections of the source code. The encoder model may be specific to the pre-translated code, that is, it may be trained on only pre-translated code of the same format or language of the source code. Alternatively, the encoder model may be trained on multiple pre-translated code formats or languages. The component sections may be entire sections, parts, files, or the whole of the source code or may be subsections of sections or files of source code provided, ranging from a single term, variable, or line of code up to multiple lines of codes or an entire file. The component sections may be non-contiguous, that is, the component sections may represent only certain selections of lines of code without inclusion of the lines of code between two component sections. Using smaller component sections enables more precise matching with the translated code. Each component section may be encoded to a vector embedding in a latent space, which is then stored in association with the source code file or part that the source code component section vector represents. The encoder may permit the resulting vector embedding of the source code to be of whatever dimensionality is helpful in the scenario to promote a comprehensive encoding of the source code, or the encoder may be provided with a limit of a maximum number of dimensions for source code vector embeddings. The component section vectors and corresponding source code parts or files may be stored in a source code vector database for future referencing.

The vector embeddings of the encoder model may be processed by a contrastive loss function so the vector embeddings may be used for comparison in a similarity search in the same embedding space. The contrastive loss function may be used to determine which vector components are similar and effective for similarity comparison for known pairs of similar pre-translated code and translated code, or, conversely, which other vector components are dissimilar (i.e., penalized with loss) and less effective for similarity comparison for known pairs of similar pre-translated code and translated code.

In a further embodiment, the encoder may use abstract syntax trees or parse trees to determine a structure of the source code by which to divide subsections for which generation of source code component section vectors is to be performed. The encoder model, if receiving a section of source code that is sufficiently long, may use a function for generating an abstract syntax tree or parse tree to generate a tree for digesting the source code into subsections. The function for generating the abstract syntax tree or parse tree may be language dependent or independent to the pre-translated code language of the source code. The generated tree represents the structure of the source code with nodes representing elements of the code containing syntactic detail and edges representing relationships between those nodes in the execution of the code. The generated tree may then be used to determine subsections of the code based on the structure of the generated tree that may be used as source code component sections for encoding as vectors in the latent space and searching against.

For example, an abstract syntax tree may be generated upon receiving an entire source code file. The abstract syntax tree may include a plurality of nodes connected by edges in a tree structure with each node being a number of connecting edges between nodes from an initial node of the tree. The source code file may be divided by determining the source code represented by each node at a certain level and all lower dependent nodes to be one subsection of source code to be used as a source code component section. For example, source code subsections may be defined at a second level of the tree where each node of the second level and all dependent nodes thereof represent one subsection of code that are divided from the other source code of the source code file and used to generate a source code component section vector embedding representing that source code subsection. Alternatively, each node of the abstract syntax tree may be used as its own subsection and the corresponding source code to that node may be encoded by the encoder model as a separate source code component section. By using abstract syntax trees or parse trees in this way, subsections of code may be created in a manner that is more efficient for searching via vector similarity search as the process respects the structure of the source code.

When a user wishes to determine a source code part or file associated with a translated code snippet, the translated code snippet may be provided by the user. The user may provide the translated code snippet by selecting a snippet from a translated code file, such as by selecting to use a snippet automatically determined by a process for determining errors or vulnerabilities within translated code. Alternatively, the user may provide the translated code snippet by selecting a file representing the translated code snippet. In another alternative, the user may provide the translated code snippet by uploading the translated code snippet via a user interface. In some cases, the code snippet may be provided in an executable format. When an executable format code snippet is provided, the code snippet may first be converted into a translated code format such as disassembling the code snippet to assembly or other translated code via a tool such as objdump or IDA Pro. An executable code snippet that is converted into a translated code format, such as assembly, may be used after conversion as the translated code snippet.

After the user provides the translated code snippet, the translated code snippet may be encoded to a vector embedding in a latent space by using a encoder model trained on translated code. The encoder model may be specific to the translated code language or syntax. In other words, the model may be trained only on translated code of the same format or translated code language or may be trained on different translated code formats and languages. In one embodiment, the encoder model may contain a plurality of encoder models, each trained on translated code of a separate translated code language and a translated code language detector for determining which encoder model to use for the translated code snippet. Alternatively, the encoder model may be trained only on translated code but may be trained on multiple translated code formats or languages. The encoder model may permit the resulting vector embedding of the set of translated code to be of whatever dimensionality is helpful in the scenario to promote a comprehensive encoding of the set of translated code, or the encoder model may be provided with a limit of a maximum number of dimensions for translated code vector embeddings.

The encoder model may be trained on tokenized data of translated code such that the encoder model learns to generate vector embeddings for input translated code. A set of translated code that is available such as an existing repository of translated code may be used as a training set, or a set of translated code may be generated for use as a training set of translated code from a source code database or library. For use in training the encoder model, the set of translated code may be tokenized such as by using a text tokenizer such as a tokenizer for programming languages. The tokens generated along with the corresponding set of translated code may then be used to train the encoder model.

The encoder model may use, as part of encoding the set of translated code into vector embeddings, a generative model to determine a functionality of the code. A request may be generated including the set of translated code to be encoded which is used to make a request to a generative model to determine functionality of the set of translated code. The generative model may determine one or more items of functionality for the set of translated code, which may then be used by the encoder model in encoding the set of translated code into a vector embedding. The items of functionality may be represented as syntactic features which may be used to develop the feature vector within the latent space for the set of translated code. The generative model may also be used to determine one or more items of functionality from a plurality of candidate items of functionality that the set of translated code does not contain. Each item of functionality of the plurality of candidate items of functionality may correspond to a feature of the latent space vectors generated for each set of set of translated code. Therefore, a determination by the generative model that a certain item of functionality of the plurality of candidate items of functionality does not exist within the set of translated code may be used to develop the feature vector within the latent space for the set of translated code by decreasing the strength of the corresponding feature for the certain item of functionality.

A translated code snippet may first be divided into translated code subsections which may each be encoded by the encoder model to generate a plurality of translated code subsection vector embeddings. A translated code subsection may be a number of lines of code, such as a basic block, function or single line subsection, up to entire files of translated code. A translated code subsection may be determined by generating an abstract syntax tree for the translated code and using the structure of the abstract syntax tree. For all use cases, if a step requires the use of the translated code snippet vector embedding, the step may be performed repeatedly for each translated code subsection vector embedding generated for the translated code snippet. In this way, multiple parts of the translated code snippet may be tracked separately for their own similarity to different or the same source code subsections. After a translated code snippet is encoded to a translated code snippet vector embedding, the translated code snippet vector embedding may be compared against vector embeddings within the source code vector database to determine a most similar source code file or part.

### Determining Similar Source Code Component Section

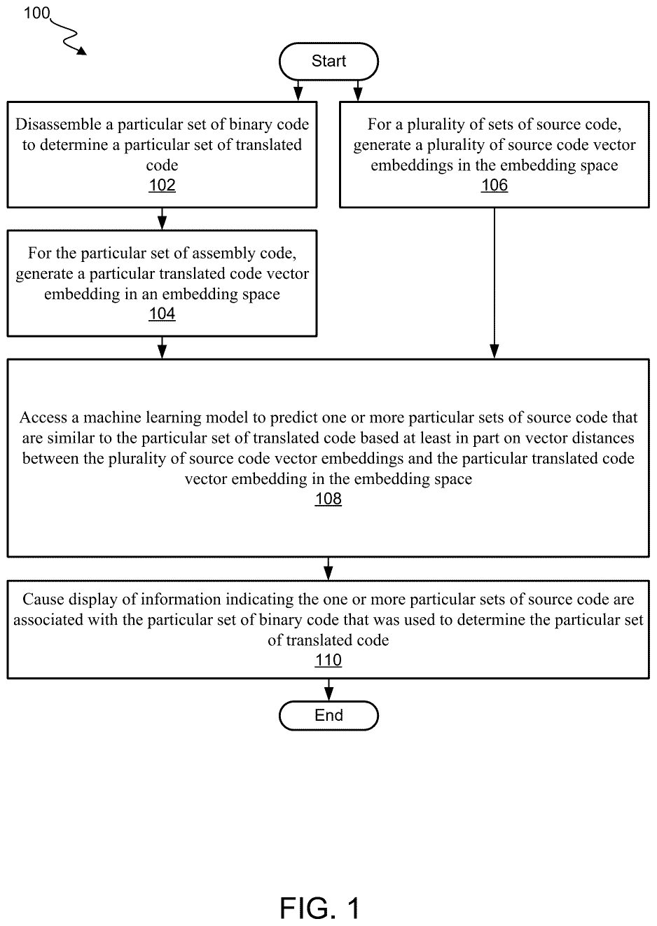

FIG. 1 depicts a method 100 for determining related source code for a set of translated code. At block 102, a particular set of executable code is disassembled to determine a particular set of translated code. At block 104, a particular translated code vector embedding is generated in an embedding space for the particular set of translated code. At block 106, a plurality of source code vector embeddings is generated in the embedding space for a plurality of sets of source code. Block 106 may be performed simultaneously, after, or prior to blocks 102-106. At block 108, a machine learning model is accessed to predict one or more particular sets of source code that are similar to the particular set of translated code based at least in part on vector distances between the plurality of source code vector embeddings and the particular translated code vector embedding in the embedding space. The machine learning model is trained on training data comprising pairs of translated code and known sets of source code. The embedding space assigns different weights to different features based at least in part on which features were similar among the pairs in the training data. At block 110, the system causes the display of information indicating the one or more particular sets of source code are associated with the particular set of executable code that was used to determine the particular set of translated code.

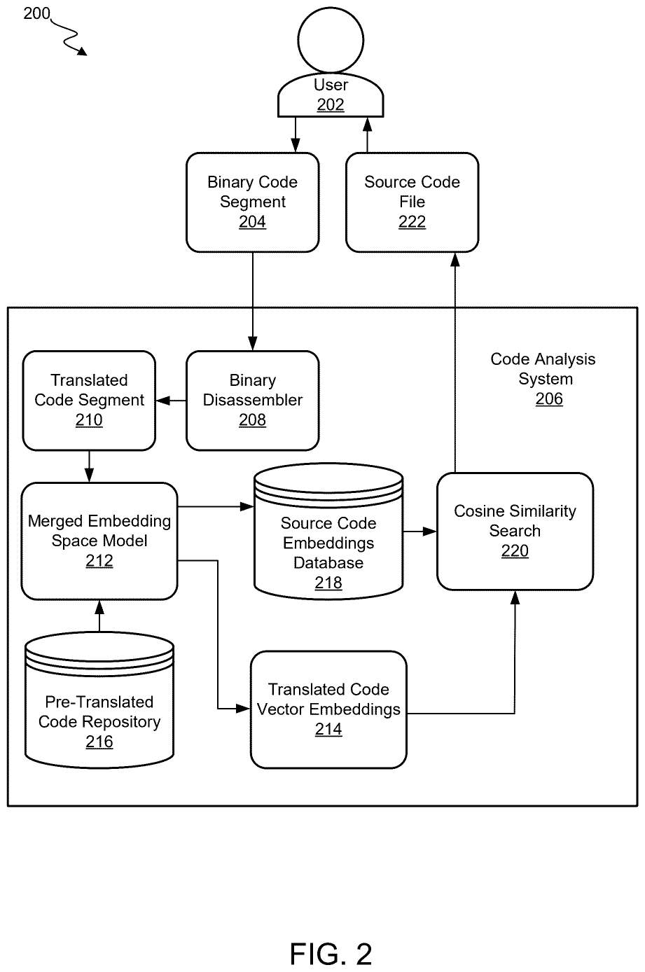

FIG. 2 depicts a system 200 for determining related source code for a set of translated code. A user 202 may submit an executable code segment 204 to a code analysis system 206. The code analysis system 206 uses a binary disassembler 208 to disassemble the executable code segment 204 and generate a translated code segment 210. The translated code segment 210 is used with the merged embedding space model 212 to generate a translated code vector embedding 214. The merged embedding space model 212 is also used with a pre-translated code repository 216 to generate source code embeddings that are stored in a source code embeddings database 218. The translated code vector embedding 214 is used to perform a cosine similarity search 220 on the source code embeddings database 218 to determine a closest source code file 222 which is provided to the user 202.

If a different encoder model is used to generate the embeddings of the translated code and the pre-translated code, the embeddings will be of a different latent space and thus a direct comparison between the vector embeddings of the translated code and the vector embeddings of the pre-translated code (for example, source code) will be inaccurate. To compare the vector embeddings directly, the vector embeddings should be brought to a shared latent space. The vector embeddings of the pre-translated code and the translated code may be brought together to a shared latent space via contrastive learning.

A contrastive learning function, or loss function, may be used to bring the vector embeddings for translated code and source code into a shared latent space for determining a similarity. A contrastive learning function or loss function addresses differences between vectors of two different latent spaces by minimizing the loss of features of vectors within different latent spaces by learning to position related concepts together in a shared latent space. A contrastive loss function may be used to minimize the distance between positive or matching pairs and maximize the distance between negative on unmatched pairs between the pre-translated code and the translated code. This process transfers semantic understanding between languages, allowing the model to map both translated code and pre-translated code into a shared latent space. The resulting vectors in the shared latent space may then be compared for similarity via a cosine similarity without influence of the particularities of the languages used.

The contrastive loss function may be trained on data from both the translated code language and the pre-translated code language used such as positive pairs of source code and its corresponding translated code. The positive pairs are constructed of pairs of translated code and corresponding pre-translated code which are equivalent in meaning. For example, positive pairs may be constructed from a database of pre-translated code which may be translated, for example, using a compiler to produce corresponding translated code which may be used as part of a positive pair with the pre-translated code used in its generation. An example database of pre-translated code may be a code repository or libraries of code for the pre-translated code language used. Negative pairs represent a pairing of translated code and pre-translated code that do not correspond. Negative pairs may be generated by constructing pairings of pre-translated code and translated code which was generated from a different pre-translated code. For example, a database of pre-translated code may be used to generate a database of translated code, which is then paired with a random other pre-translated code from the database. A similarity search may be performed between two sets of pre-translated code to determine if the two sets of pre-translated code are not similar. Any two sets of pre-translated code may be used to generate translated code that, when paired with the pre-translated code of the other set of pre-translated code may generate a negative pair.

The contrastive loss function may also be validated before use. To validate the contrastive loss function, further positive and negative pairs of pre-translated and translated code may be used to validate that the contrastive loss function generates the expected output. A positive or negative pair may be used by using the contrastive loss function on a vector embedding generated for the pre-translated code and the translated code to generated vector embeddings for each within the shared latent space of the contrastive loss function. For positive pairs, the contrastive loss function is further validated if the resulting pre-translated code vector embedding of the shared latent space and the resulting translated code vector embedding of the shared latent space are sufficiently similar or have a similarity measure, such as a cosine similarity, that is above a pre-defined threshold. For negative pairs, the contrastive loss function is further validated if the resulting pre-translated code vector embedding of the shared latent space and the resulting translated code vector embedding of the shared latent space are sufficiently unsimilar or have a similarity measure, such as a cosine similarity, that is below a pre-defined threshold.

Similarity between the translated code snippet vector and any source code vector embedding of the source code vector database may be determined by applying any distance algorithm across the source code vector database. An example distance algorithm may be performing a cosine similarity calculation between the translated code snippet vector and each vector of the source code vector database. A cosine similarity calculation calculates the cosine of the angle between two vectors, a query vector and a current vector for comparison, which may then be compared to the resulting cosine of the angle between the query vector and all other vectors compared from the database. A vector with the smallest cosine of the angle between the vector and the query vector, in this case the translated code snippet vector, is the closest vector of the source code vector database. By performing a cosine similarity comparison between the translated code snippet and each source code vector of the source code vector database, a nearest neighbor search may be used to find a list of most similar source code component sections to the translated code snippet.

For large source code databases, an approximate nearest neighbor search may also be performed by grouping vectors of the source code vector database. For example, searches of vectors of the source code vector database may be made faster by using graph techniques and grouping vectors based on certain dimensions of the vectors or certain semantics represented by subsets of dimensions of the vectors. In one example, the use of a certain variable within a plurality of source code subsections may be represented by a common range of values for a certain dimension of the source code vector embeddings. A first step of performing a similarity search between the translated code snippet vector and the source code vectors of the source code vector database may be to determine if the value of the certain dimension of the translated code snippet vector is within the common range of values and, if so, searching only those source code vectors that also have a value for the certain dimension that is within the common range of values to determine the closest source code vectors.

Alternatively or in addition to grouping vectors by certain dimensions, vectors may be grouped by the existence of certain keywords, such as keywords associated with specialized classes, methods, functions, variables, or other string references within the corresponding source code and/or translated code. For example, searches of vectors of the source code vector database may be made faster by using graph techniques and grouping vectors based on whether one or more keywords are used within the source code corresponding to the vectors. In one example, the use of a certain variable within a plurality of source code subsections may be detected as a use of a keyword and the corresponding vectors may be grouped for faster searching. A first step of performing a similarity search between the translated code snippet vector and the source code vectors of the source code vector database may be to determine if one or more keywords exist within the translated code snippet. One or more detected keywords of the one or more keywords may exist within the translated code snippet. In performing a similarity search on the source code component sections, the search may be performed within only those source code vectors where the corresponding source code component section is determined to contain the same one or more detected keywords. Keywords for detection may be determined in advance of receiving the translated code snippet, in which case the search for pre-determined keywords may be performed on all source code component sections of the source code database such that all source code component sections and their corresponding source code component section vectors may be labeled within the source code vector database with the keywords detected within the source code component section.

Alternatively, keywords may be detected from the translated code snippet when received, such as by a means of detecting the use of certain variables within the translated code. In this case, a text search may be performed for the variable within the source code component sections of the source code vector database to determine a number of source code component section vectors as a group for the similarity search based on the detection of the keywords within the corresponding source code component section. The search of source code component sections for a keyword detected from the translated code may be aided by first filtering results of the source code vector database by a certain dimension of the source code component section vectors determined to be the most affected by the presence of the keyword. For example, the encoder model may be used to generate a vector embedding of the keyword, and a largest dimension of the resulting vector embedding may be determined. The largest dimension of the keyword vector embedding may then be used as a keyword indicator dimension and source code component sections of the source code vector database may be filtered based on the value of the keyword indicator dimension of the source code component section vector being above a certain threshold.

In an additional embodiment, the similarity search may also use abstract syntax trees to reduce the combinations of candidate similar source code vector embeddings from the source code vector database. When determining a number of source code vector embeddings to search within, an abstract syntax tree may be used to determine subsections of code of similar structure between translated code and pre-translated code. An abstract syntax tree may be generated for a translated code snippet when received from a user. The source code vector database may have stored abstract syntax tree structures for each of the source code component sections that were generated when subsections of the source code were determined for use as source code component sections. The structure of the translated code abstract syntax tree, or vector embeddings of each portion thereof, may be compared to the stored abstract syntax tree structure for each source code component section to determine if a similarity exists. If the translated code abstract syntax tree structure has a portion that is of sufficient similarity to a portion of the structure of the stored abstract syntax tree structure for a source code component section, then the source code component section may be stored as a candidate source code component section that may correspond to the portion of the translated code abstract syntax tree structure.

A similarity search may be performed on source code component sections that represent files of the source code and a separate similarity search may be performed on source code component sections that represent subsections of the source code. For example, a first similarity search may be performed to determine a most similar source code file. The source code file may be divided into subsections, of which each subsection is used with the encoder model to determine a set of vector embeddings for each of the source code subsections. The source code subsections may then be searched via a similarity search to determine a subsection of the source code file that is most similar to the translated code snippet. The dividing of a source code file and generating of subsection vector embeddings may be performed in advance of receiving a translated code snippet from a user.

In an alternative embodiment, a database of translated code and/or corresponding executable code may be stored with generated vector embeddings. The database of translated code may then be searched by a similarity search against a user-submitted source code snippet, which is encoded into a vector embedding and compared to the stored vector embeddings of the translated code within the translated code database. In this alternative embodiment, the same process of a similarity search of vector embeddings of translated and pre-translated code may be used to determine a corresponding portion of translated code without the need to perform a potentially lengthy compiling process on the pre-translated code.

### Display of Predicted Similar Source Code

Results of the similarity search between the translated code snippet and the source code component sections may be displayed on a user interface. The source code component sections determined to be most similar may be displayed in a ranked list of two or more most similar source code component sections along with information about the file such as a file location and a determined measure of similarity. A determined measure of similarity may be represented for any determined similar source code component sections. A determined measure of similarity may be represented as a percentage similarity based on the proximity of the vector embeddings of the translated code snippet and the source code component section or the percentage deviation of the source code component section vector embedding from the translated code snippet vector embedding.

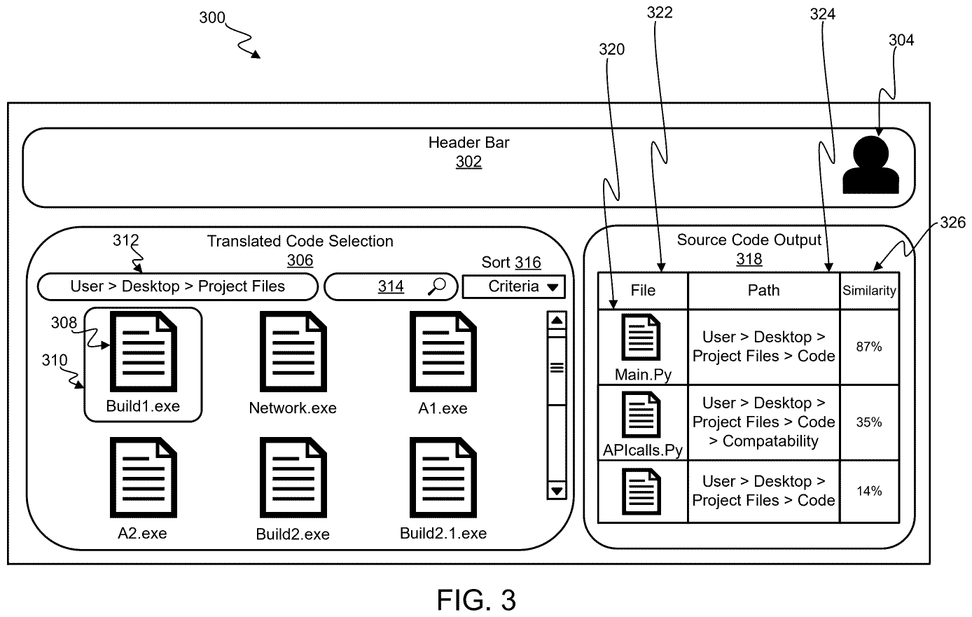

FIG. 3 depicts an example user interface 300 for determining related source code for a set of translated code. The example user interface 300 may include a header bar 302 indicating a recognition of the user 304 via a set of user credentials. The set of user credentials may be used to confirm data access rights by the user. The example user interface 300 also contains a translated code selection region 306 for selecting a file 308 for use as the translated code snippet. The translated code selection region 306 may include an indication 310, of a currently selected translated code file 308. For navigation of files, the translated code selection region 306 may contain a file navigation region 312 for navigating between file directories. The translated code selection region 306 may also contain a search function 314 for searching the name of a specific file, either within the currently selected file directory within the file navigation region 312 or across a computer storage. The translated code selection region 306 may also contain a sort function 316 for controlling the order of the display of currently displayed files within the translated code selection region 306 such as by ordering the currently displayed files by size of file. The user interface 300 may also contain a source code output region 318 for displaying the results of a matching between the currently selected translated code file 308 and one or more source code files 320. For each source code file 320 determined to be similar to the selected translated code file 308, the source code output region 318 may display a file name 322, a file path 324 showing the location of the file on computer storage, and a measure of determined similarity 326 such as a percentage similarity.

Similarity detected via a similarity between vector embeddings may be confirmed by detecting the functionality within the translated code and corresponding predicted similar source code. A request may be made to a generative model to determine a functionality of the translated code snippet. The functionality for the translated code snippet may be stored in association with the translated code snippet. After performing a similarity search to determine a set of source code component sections that are most similar to the translated code snippet, a request may be made to a generative model with each of the source code component sections of the set of source code component sections to determine a functionality of the source code component sections. The determined functionality of each source code component section of the set of source code component sections may then be compared with the stored determined functionality of the translated code snippet. Alternatively, a request may be made to the generative model with the set of source code component sections and the determined functionality of the translated code snippet to determine which of the source code component sections of the set of source code component sections comprise the functionality of the translated code snippet. The results of the generative model's determination of functionality may be compared with a determined measure of similarity for each of the source code component sections to determine a most likely source code component section that corresponds to the translated code snippet.

Display of the determined most similar source code component section, particularly in the case where the source code component section is a subsection of a source code file, may be displayed by displaying a section of the text of the source code file for viewing by the user. For example, the determined most similar source code file may be displayed in a code viewing window, optionally with a subsection of the source code file displayed as a current section of the source code file wherein the subsection of the source code file was determined to be a most similar subsection of the source code file to the translated code snippet. The code viewing window may display a plurality of determined similar source code component sections, which may be non-contiguous to each other representing multiple locations throughout the source code that may correspond to the translated code snippet. The source code file may be displayed with annotations, such as a highlighting of the most similar subsection of the source code file. The annotation may indicate one or more subsections of the source code that correspond to one or more subsections of the translated code snippet. The source code file may be displayed in conjunction with the translated code snippet along with annotations indicating similarities or similar features of the source code file and the translated code snippet. For example, the source code file may be displayed with highlighting of a particular subsection of the source code file and a corresponding highlighting of a subsection of the translated code snippet.

By use of the display of the most similar source code component section, a user analyzing the code can better understand the function of a translated code or executable code snippet. Using the embodiments disclosed herein, a user may be able to determine function of the code beyond what the user was capable to through mere analysis of the translated code or executable code snippet alone. The greater ability to analyze the function of translated code provided by the embodiments disclosed herein creates a greater efficiency in the development of software as the detection and repair of errors or vulnerabilities in source code is more easily and efficiently detected.

In a further example, a translated code or executable code snippet may be available without the corresponding source code that generated the translated code being available. A user may use the method above to analyze the translated code or executable code snippet by comparison to other available source code such as open source software source code. By the display of similar source code component sections that are most similar to the translated code or executable code snippet, the user may determine a general functionality of the translated code or executable code snippet that was obfuscated by the lack of syntax within the translated code or executable code. If the display includes a highlighting of a most similar subsection of the source code used, the user may be able to determine discrete functions that likely exist within the source code that generated the translated code or executable code snippet which the user may not have been able to determine based solely on analysis of the translated code.

### Computer System Architecture

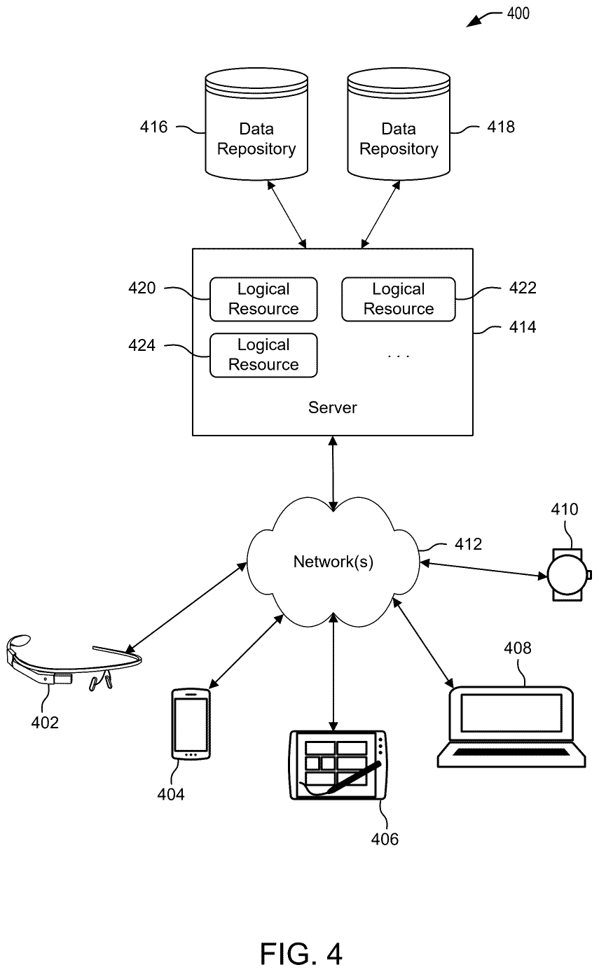

FIG. 4 depicts a simplified diagram of a distributed system 400 for implementing an embodiment. In the illustrated embodiment, distributed system 400 includes one or more client computing devices 402, 404, 406, 408, and/or 410 coupled to a server 414 via one or more communication networks 412. Clients computing devices 402, 404, 406, 408, and/or 410 may be configured to execute one or more applications.

In various aspects, server 414 may be adapted to run one or more services or software applications that enable techniques for code analysis.

In certain aspects, server 414 may also provide other services or software applications that can include non-virtual and virtual environments. In some aspects, these services may be offered as web-based or cloud services, such as under a Software as a Service (SaaS) model to the users of client computing devices 402, 404, 406, 408, and/or 410. Users operating client computing devices 402, 404, 406, 408, and/or 410 may in turn utilize one or more client applications to interact with server 414 to utilize the services provided by these components.

In the configuration depicted in FIG. 4, server 414 may include one or more components 420, 422 and 424 that implement the functions performed by server 414. These components may include software components that may be executed by one or more processors, hardware components, or combinations thereof. It should be appreciated that various different system configurations are possible, which may be different from distributed system 400. The embodiment shown in FIG. 4 is thus one example of a distributed system for implementing an embodiment system and is not intended to be limiting.

Users may use client computing devices 402, 404, 406, 408, and/or 410 for techniques for code analysis in accordance with the teachings of this disclosure. A client device may provide an interface that enables a user of the client device to interact with the client device. The client device may also output information to the user via this interface. Although FIG. 4 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux®or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 412 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 412 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 414 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 414 can include one or more virtual machines running virtual operating systems, or other computing architectures involving virtualization such as one or more flexible pools of logical storage devices that can be virtualized to maintain virtual storage devices for the server. In various aspects, server 414 may be adapted to run one or more services or software applications that provide the functionality described in the foregoing disclosure.

The computing systems in server 414 may run one or more operating systems including any of those discussed above, as well as any commercially available server operating system. Server 414 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 414 may include one or more applications to analyze and consolidate data feeds and/or event updates received from users of client computing devices 402, 404, 406, 408, and/or 410. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 414 may also include one or more applications to display the data feeds and/or real-time events via one or more display devices of client computing devices 402, 404, 406, 408, and/or 410.

Distributed system 400 may also include one or more data repositories 416, 418. These data repositories may be used to store data and other information in certain aspects. For example, one or more of the data repositories 416, 418 may be used to store information for techniques for code analysis. Data repositories 416, 418 may reside in a variety of locations. For example, a data repository used by server 414 may be local to server 414 or may be remote from server 414 and in communication with server 414 via a network-based or dedicated connection. Data repositories 416, 418 may be of different types. In certain aspects, a data repository used by server 414 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 416, 418 may also be used by applications to store application data. The data repositories used by applications may be of different types such as, for example, a key-value store repository, an object store repository, or a general storage repository supported by a file system.

In one embodiment, server 414 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

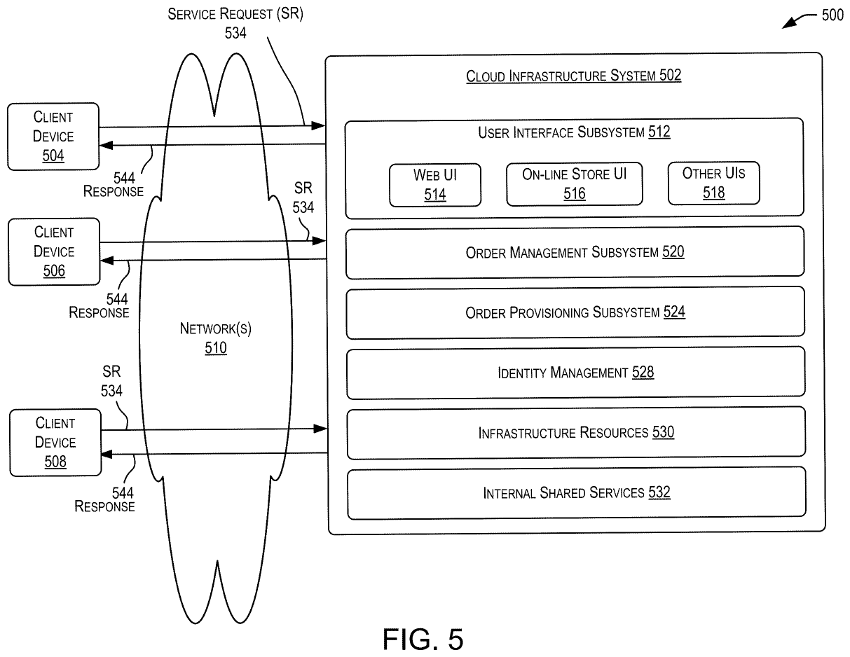

FIG. 5 is a simplified block diagram of a cloud-based system environment in which code analysis, in accordance with certain aspects. In the embodiment depicted in FIG. 5, cloud infrastructure system 502 may provide one or more cloud services that may be requested by users using one or more client computing devices 504, 506, and 508. Cloud infrastructure system 502 may comprise one or more computers and/or servers that may include those described above for server 414. The computers in cloud infrastructure system 502 may be organized as general purpose computers, specialized server computers, server farms, server clusters, or any other appropriate arrangement and/or combination.

Network(s) 510 may facilitate communication and exchange of data between clients 504, 506, and 508 and cloud infrastructure system 502. Network(s) 510 may include one or more networks. The networks may be of the same or different types. Network(s) 510 may support one or more communication protocols, including wired and/or wireless protocols, for facilitating the communications.

The embodiment depicted in FIG. 5 is only one example of a cloud infrastructure system and is not intended to be limiting. It should be appreciated that, in some other aspects, cloud infrastructure system 502 may have more or fewer components than those depicted in FIG. 5, may combine two or more components, or may have a different configuration or arrangement of components. For example, although FIG. 5 depicts three client computing devices, any number of client computing devices may be supported in alternative aspects.

The term cloud service is generally used to refer to a service that is made available to users on demand and via a communication network such as the Internet by systems (e.g., cloud infrastructure system 502) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 510 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 502 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 502 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 502. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 502. Cloud infrastructure system 502 then performs processing to provide the services requested in the tenant's subscription order. Cloud infrastructure system 502 may be configured to provide one or even multiple cloud services.

Cloud infrastructure system 502 may provide the cloud services via different deployment models. In a public cloud model, cloud infrastructure system 502 may be owned by a third party cloud services provider and the cloud services are offered to any general public tenant, where the tenant can be an individual or an enterprise. In certain other aspects, under a private cloud model, cloud infrastructure system 502 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 502 and the services provided may be shared by several organizations in a related community. Various other models such as hybrids of the above mentioned models may also be used.

Client computing devices 504, 506, and 508 may be of different types (such as devices 402, 404, 406, and 408 depicted in FIG. 4) and may be capable of operating one or more client applications. A user may use a client device to interact with cloud infrastructure system 502, such as to request a service provided by cloud infrastructure system 502.

In some aspects, the processing performed by cloud infrastructure system 502 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 502 for determining the intent of an utterance. The data used for this analysis may include structured data (e.g., data stored in a database or structured according to a structured model) and/or unstructured data (e.g., data blobs (binary large objects)).

As depicted in the embodiment in FIG. 5, cloud infrastructure system 502 may include infrastructure resources 530 that are utilized for facilitating the provision of various cloud services offered by cloud infrastructure system 502. Infrastructure resources 530 may include, for example, processing resources, storage or memory resources, networking resources, and the like.

In certain aspects, to facilitate efficient provisioning of these resources for supporting the various cloud services provided by cloud infrastructure system 502 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 502 may itself internally use services 532 that are shared by different components of cloud infrastructure system 502 and which facilitate the provisioning of services by cloud infrastructure system 502. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 502 may comprise multiple subsystems. These subsystems may be implemented in software, or hardware, or combinations thereof. As depicted in FIG. 5, the subsystems may include a user interface subsystem 512 that enables users of cloud infrastructure system 502 to interact with cloud infrastructure system 502. User interface subsystem 512 may include various different interfaces such as a web interface 514, an online store interface 516 where cloud services provided by cloud infrastructure system 502 are advertised and are purchasable by a consumer, and other interfaces 518. For example, a tenant may, using a client device, request (service request 534) one or more services provided by cloud infrastructure system 502 using one or more of interfaces 514, 516, and 518. For example, a tenant may access the online store, browse cloud services offered by cloud infrastructure system 502, and place a subscription order for one or more services offered by cloud infrastructure system 502 that the tenant wishes to subscribe to. The service request may include information identifying the tenant and one or more services that the tenant desires to subscribe to. For example, a tenant may place a subscription order for a chatbot related service offered by cloud infrastructure system 502. As part of the order, the client may provide information identifying the input (e.g. utterances).

In certain aspects, such as the embodiment depicted in FIG. 5, cloud infrastructure system 502 may comprise a service management subsystem (OMS) 520 that is configured to process the new order. As part of this processing, OMS 520 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 520 may then invoke the service provisioning subsystem (OPS) 524 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 524 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 502 may send a response or notification 544 to the requesting tenant to indicate when the requested service is now ready for use. In some instances, information (e.g., a link) may be sent to the tenant that enables the tenant to start using and availing the benefits of the requested services.

Cloud infrastructure system 502 may provide services to multiple tenants. For each tenant, cloud infrastructure system 502 is responsible for managing information related to one or more subscription orders received from the tenant, maintaining tenant data related to the orders, and providing the requested services to the tenant or clients of the tenant. Cloud infrastructure system 502 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 502 may provide services to multiple tenants in parallel. Cloud infrastructure system 502 may store information for these tenants, including possibly proprietary information. In certain aspects, cloud infrastructure system 502 comprises an identity management subsystem (IMS) 528 that is configured to manage tenant's information and provide the separation of the managed information such that information related to one tenant is not accessible by another tenant. IMS 528 may be configured to provide various security-related services such as identity services, such as information access management, authentication and authorization services, services for managing tenant identities and roles and related capabilities, and the like.

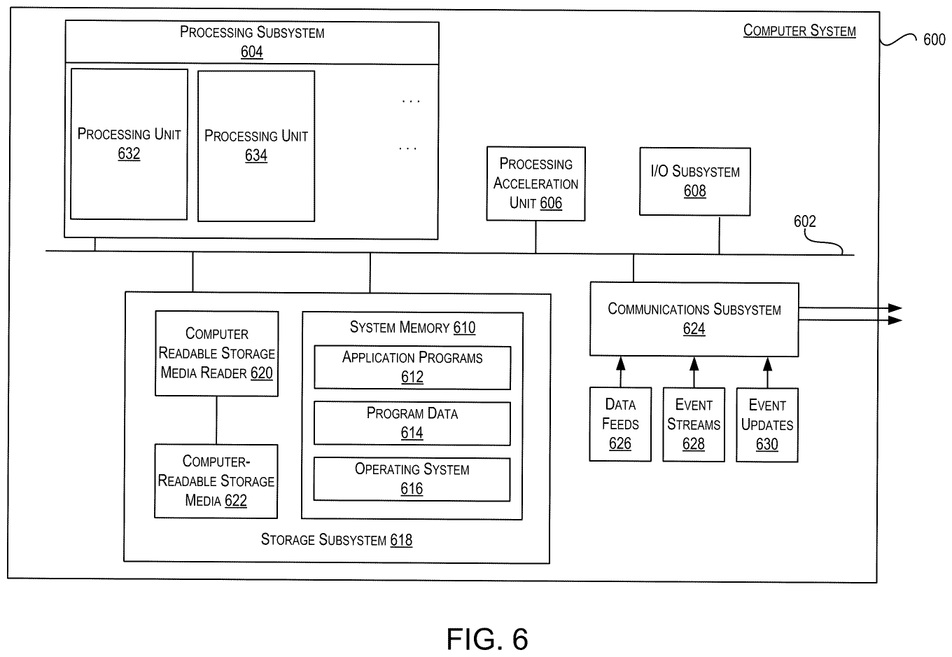

FIG. 6 illustrates an exemplary computer system 600 that may be used to implement certain aspects. As shown in FIG. 6, computer system 600 includes various subsystems including a processing subsystem 604 that communicates with a number of other subsystems via a bus subsystem 602. These other subsystems may include a processing acceleration unit 606, an I/O subsystem 608, a storage subsystem 618, and a communications subsystem 624. Storage subsystem 618 may include non-transitory computer-readable storage media including storage media 622 and a system memory 610.

Bus subsystem 602 provides a mechanism for letting the various components and subsystems of computer system 600 communicate with each other as intended. Although bus subsystem 602 is shown schematically as a single bus, alternative aspects of the bus subsystem may utilize multiple buses. Bus subsystem 602 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 604 controls the operation of computer system 600 and may comprise one or more processors, application specific integrated circuits (ASICs), or field programmable gate arrays (FPGAs). The processors may be single core or multicore processors. The processing resources of computer system 600 can be organized into one or more processing units 632, 634, etc. A processing unit may include one or more processors, one or more cores from the same or different processors, a combination of cores and processors, or other combinations of cores and processors. In some aspects, processing subsystem 604 can include one or more special purpose co-processors such as graphics processors, digital signal processors (DSPs), or the like. In some aspects, some or all of the processing units of processing subsystem 604 can be implemented using customized circuits, such as application specific integrated circuits (ASICs), or field programmable gate arrays (FPGAs).

In some aspects, the processing units in processing subsystem 604 can execute instructions stored in system memory 610 or on computer readable storage media 622. In various aspects, the processing units can execute a variety of programs or code instructions and can maintain multiple concurrently executing programs or processes. At any given time, some or all of the code to be executed can be resident in system memory 610 and/or on computer-readable storage media 622 including potentially on one or more storage devices. Through suitable programming, processing subsystem 604 can provide various functionalities described above. In instances where computer system 600 is executing one or more virtual machines, one or more processing units may be allocated to each virtual machine.

In certain aspects, a processing acceleration unit 606 may optionally be provided for performing customized processing or for off-loading some of the processing performed by processing subsystem 604 so as to accelerate the overall processing performed by computer system 600.

I/O subsystem 608 may include devices and mechanisms for inputting information to computer system 600 and/or for outputting information from or via computer system 600. In general, use of the term input device is intended to include all possible types of devices and mechanisms for inputting information to computer system 600. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 600 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 618 provides a repository or data store for storing information and data that is used by computer system 600. Storage subsystem 618 provides a tangible non-transitory computer-readable storage medium for storing the basic programming and data constructs that provide the functionality of some aspects. Storage subsystem 618 may store software (e.g., programs, code modules, instructions) that when executed by processing subsystem 604 provides the functionality described above. The software may be executed by one or more processing units of processing subsystem 604. Storage subsystem 618 may also provide a repository for storing data used in accordance with the teachings of this disclosure.

Storage subsystem 618 may include one or more non-transitory memory devices, including volatile and non-volatile memory devices. As shown in FIG. 6, storage subsystem 618 includes a system memory 610 and a computer-readable storage media 622. System memory 610 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 600, such as during start-up, may typically be stored in the ROM. The RAM typically contains data and/or program modules that are presently being operated and executed by processing subsystem 604. In some implementations, system memory 610 may include multiple different types of memory, such as static random access memory (SRAM), dynamic random access memory (DRAM), and the like.

By way of example, and not limitation, as depicted in FIG. 6, system memory 610 may load application programs 612 that are being executed, which may include various applications such as Web browsers, mid-tier applications, relational database management systems (RDBMS), etc., program data 614, and an operating system 616. By way of example, operating system 616 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 622 may store programming and data constructs that provide the functionality of some aspects. Computer-readable media 622 may provide storage of computer-readable instructions, data structures, program modules, and other data for computer system 600. Software (programs, code modules, instructions) that, when executed by processing subsystem 604 provides the functionality described above, may be stored in storage subsystem 618. By way of example, computer-readable storage media 622 may include non-volatile memory such as a hard disk drive, a magnetic disk drive, an optical disk drive such as a CD ROM, digital video disc (DVD), a Blu-Ray® disk, or other optical media. Computer-readable storage media 622 may include, but is not limited to, Zip® drives, flash memory cards, universal serial bus (USB) flash drives, secure digital (SD) cards, DVD disks, digital video tape, and the like. Computer-readable storage media 622 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 618 may also include a computer-readable storage media reader 620 that can further be connected to computer-readable storage media 622. Reader 620 may receive and be configured to read data from a memory device such as a disk, a flash drive, etc.

In certain aspects, computer system 600 may support virtualization technologies, including but not limited to virtualization of processing and memory resources. For example, computer system 600 may provide support for executing one or more virtual machines. In certain aspects, computer system 600 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 600. Accordingly, multiple operating systems may potentially be run concurrently by computer system 600.

Communications subsystem 624 provides an interface to other computer systems and networks. Communications subsystem 624 serves as an interface for receiving data from and transmitting data to other systems from computer system 600. For example, communications subsystem 624 may enable computer system 600 to establish a communication channel to one or more client devices via the Internet for receiving and sending information from and to the client devices. For example, the communications subsystem may be used to transmit a response to a user regarding the inquiry for a chatbot.

Communications subsystem 624 may support both wired and/or wireless communication protocols. For example, in certain aspects, communications subsystem 624 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 624 can provide wired network connectivity (e.g., Ethernet) in addition to or instead of a wireless interface.

Communications subsystem 624 can receive and transmit data in various forms. For example, in some aspects, in addition to other forms, communications subsystem 624 may receive input communications in the form of structured and/or unstructured data feeds 626, event streams 628, event updates 630, and the like. For example, communications subsystem 624 may be configured to receive (or send) data feeds 626 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 624 may be configured to receive data in the form of continuous data streams, which may include event streams 628 of real-time events and/or event updates 630, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 624 may also be configured to communicate data from computer system 600 to other computer systems or networks. The data may be communicated in various different forms such as structured and/or unstructured data feeds 626, event streams 628, event updates 630, and the like to one or more databases that may be in communication with one or more streaming data source computers coupled to computer system 600.

Computer system 600 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 600 depicted in FIG. 6 is intended only as a specific example. Many other configurations having more or fewer components than the system depicted in FIG. 6 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
disassembling a particular set of executable code to determine a particular set of translated code;
for the particular set of translated code, generating a particular translated code vector embedding in an embedding space;
for a plurality of sets of source code, generating a plurality of source code vector embeddings in the embedding space;
accessing a machine learning model trained on training data comprising pairs of sets of translated code and known sets of source code to predict one or more particular sets of source code that are similar to the particular set of translated code based at least in part on vector distances between the plurality of source code vector embeddings and the particular translated code vector embedding in the embedding space; wherein the embedding space assigns different weights to different features based at least in part on which features were similar among the pairs in the training data; and
causing display of information indicating the one or more particular sets of source code are associated with the particular set of executable code.

2. The computer-implemented method of claim 1, wherein the one or more particular sets of source code comprise two or more particular sets of source code that are each similar to the particular set of translated code, the computer-implemented method further comprising ranking the two or more particular sets of source code based at least in part on a cosine distance between a vector embedding of each of the two or more particular sets of source code and the particular translated code vector embedding, and wherein causing display of the information comprises causing display of the two or more particular sets of source code according to the ranking.

3. The computer-implemented method of claim 1, wherein the pairs of sets of translated code and known sets of source code are processed by a contrastive loss function to determine which vector components are similar for the pairs and which other vector components are dissimilar for the pairs.

4. The computer-implemented method of claim 1, further comprising:
generating another particular vector embedding of a particular subset of the particular set of translated code in the embedding space;
generating another plurality of source code vector embeddings for a plurality of subsets of source code in the embedding space; and
accessing the machine learning model to predict one or more particular subsets of source code that are similar to the particular subset of the particular set of translated code based at least in part on vector distances between the other plurality of source code vector embeddings and the other particular vector embedding in the embedding space.

5. The computer-implemented method of claim 1, wherein generating the particular translated code vector embedding in the embedding space comprises:
generating a first particular vector embedding of a first particular subset of translated code in the embedding space; and
generating a second particular vector embedding of a second particular subset of translated code in the embedding space;
wherein generating the plurality of source code vector embeddings in the embedding space comprises:
generating the plurality of source code vector embeddings for a plurality of subsets of source code in the embedding space;
wherein accessing the machine learning model to predict one or more particular sets of source code that are similar to the particular set of translated code comprises:
accessing the machine learning model to predict a first particular subset of source code that is similar to the first particular subset of translated code based at least in part on vector distances between the plurality of source code vector embeddings and the first particular vector embedding; and
accessing the machine learning model to predict a second particular subset of source code that is similar to the second particular subset of translated code based at least in part on vector distances between the plurality of source code vector embeddings and the second particular vector embedding.

6. The computer-implemented method of claim 5, wherein the first particular subset of source code is non-contiguous with the second particular subset of source code.

7. The computer-implemented method of claim 1, wherein causing display of the information comprises annotating different parts of translated code corresponding to the particular set of executable code; wherein the annotating marks the different parts of the translated code with corresponding parts of the one or more particular sets of source code.

8. A computer-program product comprising one or more non-transitory machine-readable storage media, including stored instructions configured to cause a computing system to perform a set of actions including:
disassembling a particular set of executable code to determine a particular set of translated code;
for the particular set of translated code, generating a particular translated code vector embedding in an embedding space;
for a plurality of sets of source code, generating a plurality of source code vector embeddings in the embedding space;
accessing a machine learning model trained on training data comprising pairs of sets of translated code and known sets of source code to predict one or more particular sets of source code that are similar to the particular set of translated code based at least in part on vector distances between the plurality of source code vector embeddings and the particular translated code vector embedding in the embedding space; wherein the embedding space assigns different weights to different features based at least in part on which features were similar among the pairs in the training data; and
causing display of information indicating the one or more particular sets of source code are associated with the particular set of executable code.

9. The computer-program product of claim 8, wherein the one or more particular sets of source code comprise two or more particular sets of source code that are each similar to the particular set of translated code, the set of actions further including ranking the two or more particular sets of source code based at least in part on a cosine distance between vector embeddings of each of the two or more particular sets of source code and the particular translated code vector embedding, and wherein causing display of the information comprises causing display of the two or more particular sets of source code according to the ranking.

10. The computer-program product of claim 8, wherein the pairs of sets of translated code and known sets of source code are processed by a contrastive loss function to determine which vector components are similar for the pairs and which other vector components are dissimilar for the pairs.

11. The computer-program product of claim 8, wherein the set of actions further includes:
generating another particular vector embedding of a particular subset of the particular set of translated code in the embedding space;
generating another plurality of source code vector embeddings for a plurality of subsets of source code in the embedding space; and
accessing the machine learning model to predict one or more particular subsets of source code that are similar to the particular subset of the particular set of translated code based at least in part on vector distances between the other plurality of source code vector embeddings and the other particular vector embedding in the embedding space.

12. The computer-program product of claim 8, wherein generating the particular translated code vector embedding in the embedding space comprises:
generating a first particular vector embedding of a first particular subset of translated code in the embedding space; and
generating a second particular vector embedding of a second particular subset of translated code in the embedding space;
wherein generating the plurality of source code vector embeddings in the embedding space comprises:
generating the plurality of source code vector embeddings for a plurality of subsets of source code in the embedding space;
wherein accessing the machine learning model to predict one or more particular sets of source code that are similar to the particular set of translated code comprises:
accessing the machine learning model to predict a first particular subset of source code that is similar to the first particular subset of translated code based at least in part on vector distances between the plurality of source code vector embeddings and the first particular vector embedding; and
accessing the machine learning model to predict a second particular subset of source code that is similar to the second particular subset of translated code based at least in part on vector distances between the plurality of source code vector embeddings and the second particular vector embedding.

13. The computer-program product of claim 12, wherein the first particular subset of source code is non-contiguous with the second particular subset of source code.

14. The computer-program product of claim 11, wherein causing display of the information comprises annotating different parts of translated code corresponding to the particular set of executable code; wherein the annotating marks the different parts of the translated code with corresponding parts of the one or more particular sets of source code.

15. A system comprising:
one or more processors;
one or more non-transitory computer-readable media storing instructions, which, when executed by the system, cause the system to perform a set of actions including:
disassembling a particular set of executable code to determine a particular set of translated code;
for the particular set of translated code, generating a particular translated code vector embedding in an embedding space;
for a plurality of sets of source code, generating a plurality of source code vector embeddings in the embedding space;
accessing a machine learning model trained on training data comprising pairs of sets of translated code and known sets of source code to predict one or more particular sets of source code that are similar to the particular set of translated code based at least in part on vector distances between the plurality of source code vector embeddings and the particular translated code vector embedding in the embedding space; wherein the embedding space assigns different weights to different features based at least in part on which features were similar among the pairs in the training data; and
causing display of information indicating the one or more particular sets of source code are associated with the particular set of executable code.

16. The system of claim 15, wherein the one or more particular sets of source code comprise two or more particular sets of source code that are each similar to the particular set of translated code, the set of actions further including ranking the two or more particular sets of source code based at least in part on a cosine distance between vector embeddings of each of the two or more particular sets of source code and the particular translated code vector embedding, and wherein causing display of the information comprises causing display of the two or more particular sets of source code according to the ranking.

17. The system of claim 15, wherein the pairs of sets of translated code and known sets of source code are processed by a contrastive loss function to determine which vector components are similar for the pairs and which other vector components are dissimilar for the pairs.

18. The system of claim 15, wherein the set of actions further includes:
generating another particular vector embedding of a particular subset of the particular set of translated code in the embedding space;
generating another plurality of source code vector embeddings for a plurality of subsets of source code in the embedding space; and
accessing the machine learning model to predict one or more particular subsets of source code that are similar to the particular subset of the particular set of translated code based at least in part on vector distances between the other plurality of source code vector embeddings and the other particular vector embedding in the embedding space.

19. The system of claim 15, wherein generating the particular translated code vector embedding in the embedding space comprises:
generating a first particular vector embedding of a first particular subset of translated code in the embedding space; and
generating a second particular vector embedding of a second particular subset of translated code in the embedding space;
wherein generating the plurality of source code vector embeddings in the embedding space comprises:
generating the plurality of source code vector embeddings for a plurality of subsets of source code in the embedding space;
wherein accessing the machine learning model to predict one or more particular sets of source code that are similar to the particular set of translated code comprises:
accessing the machine learning model to predict a first particular subset of source code that is similar to the first particular subset of translated code based at least in part on vector distances between the plurality of source code vector embeddings and the first particular vector embedding; and
accessing the machine learning model to predict a second particular subset of source code that is similar to the second particular subset of translated code based at least in part on vector distances between the plurality of source code vector embeddings and the second particular vector embedding.

20. The system of claim 19, wherein the first particular subset of source code is non-contiguous with the second particular subset of source code.

21. A computer-implemented method comprising:
accessing a particular set of untranslated code;
for the particular set of untranslated code, generating a particular untranslated code vector embedding in an embedding space;
for a plurality of sets of translated code, generating a plurality of translated code vector embeddings in the embedding space;
accessing a machine learning model trained on training data comprising pairs of sets of untranslated code and known sets of translated code to predict one or more particular sets of translated code that are similar to the particular set of untranslated code based at least in part on vector distances between the plurality of translated code vector embeddings and the particular untranslated code vector embedding in the embedding space; wherein the embedding space assigns different weights to different features based at least in part on which features were similar among the pairs in the training data; and
causing display of information indicating the one or more particular sets of translated code are associated with the particular set of untranslated code.

22. The computer-implemented method of claim 21, wherein the particular set of untranslated code comprises source code and the one or more particular sets of translated code comprise compiled code.
